(19) United States
(12) Patent Application Publication
(10) Pub. No.: US 2008/0275775 A1
(43) Pub. Date: Nov. 6, 2008

(54) System and method for using sampling for scheduling advertisements in an online auction

(75) Inventors: Rica Gonen, Sunnyvale, CA (US); Elan Y. Pavlov, Cambridge, MA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/800,667

(22) Filed: May 4, 2007

(51) Int. Cl. G06Q 30/00; G06F 7/60

(52) U.S. Cl. 705/14; 703/2

(57) ABSTRACT

An improved system and method is provided for using sampling for scheduling advertisements in an online auction. A multi-armed bandit engine may be provided for learning the valuation of advertisements through sampling in an online advertising auction. To do so, the multi-armed bandit may schedule advertisements for web page placements in an online advertising auction to optimize payments for maximizing the welfare of the advertisers. An initial list of advertisements may be created that is ordered by expected payment, and an optimal subset of advertisements may be determined from the initial list of advertisements for web page placements by iterative sampling. A web page placement may then be determined and allocated for each advertisement in the optimal subset in order to maximize revenue. And a charge may be calculated for each advertisement allocated the web page placement and sampled in the online advertising auction.

### FIELD OF THE INVENTION

The invention relates generally to computer systems, and more particularly to an improved system and method using sampling for scheduling advertisements in an online auction.

### BACKGROUND OF THE INVENTION

Online keyword auctions provide a mechanism for allocating a limited number of advertising slots to potential advertisers. Each advertiser can bid on a set of keywords, and the advertisers may be ranked for each keyword by multiplying the advertiser's bid times the expected click-through rate (CTR) for advertisements. The limited number of advertising slots may then be allocated to the highest ranking advertisers. Although the expected CTR may be determined for advertisements that have been previously displayed in online keyword auctions, the expected CTR for new advertisements that have not been used in an online keyword auction may unfortunately be unknown to both the advertiser and the online system conducting the keyword auction. Accordingly, an online system conducting a keyword auction must somehow allocate advertising slots without known valuations for new advertisements. It is a challenge to maximize the welfare of the participants, namely the advertisers, in defining allocations of advertising slots and payments from advertisers to an auctioneer with unknown valuations for new advertisements.

In practice, new advertisers may be allocated a number of impressions which suffice to determine the CTR within an error bound. In many cases, such sampling is costly and can yield a large loss of welfare of the participants. As an alternative, various heuristics may be utilized to estimate the click-through rate of a new advertiser. Unfortunately, such heuristics may also result in a large loss of welfare. A further complication of estimating the CTR for new advertisers in a keyword auction is that a number of advertising slots may be allocated to different advertisers in each auction round. Since these advertising slots are commonly considered to be of different quality, the auction mechanism must take into account which advertising slot is allocated to which advertiser in order to estimate the CTR.

Furthermore, estimating the CTR using various heuristics may create an incentive for an advertiser to bid on keywords using multiple aliases in order to repeatedly become “new” advertisers. Additionally, estimating the CTR may also create an incentive for advertisers to bid in a large number of auctions with very low value keywords. What is needed is a system and method for allocating advertising slots where the valuation may be unknown. Such a system and method should give advertisers an incentive to declare bids with true valuations, accurately learn the CTR for new advertisements, support multiple advertising slots of different quality, and minimize loss of welfare of the advertisers.

### SUMMARY OF THE INVENTION

Briefly, the present invention may provide a system and method using sampling for scheduling advertisements in an online auction. In an embodiment, a multi-armed bandit engine may be provided for learning the valuation of advertisements through sampling in an online advertising auction. To do so, the multi-armed bandit may schedule advertisements for web page placements in an online advertising auction to optimize payments for maximizing the welfare of the advertisers. An initial list of advertisements may be created that is ordered by expected payment, and an optimal subset of advertisements may be determined from the initial list of advertisements for web page placements by iterative sampling. A web page placement may then be determined and allocated for each advertisement in the optimal subset in order to maximize revenue to an auctioneer. And a charge may be calculated for each advertisement allocated the web page placement and sampled in the online advertising auction.

An initial list of advertisements ordered by expected payment may be created by setting an initial click-through rate for each advertisement in a set of advertisements received and then by sampling each of the advertisements once in an online advertising auction. The click-through rate for each of the sampled advertisements may be updated using a normalized number of clicks in order to compare click-through rates across web page placement locations of different quality. Sampled advertisements with an updated click-through rate lower than a threshold may be removed from the set of advertisements. The remaining advertisements may be output as an initial list of advertisement ordered by expected payoff.

If there are more advertisements in the initial list than the number of web page placements, then the advertisements may continue to be sampled in rounds in the online advertising auction. During each round, the list of advertisements may be ordered by expected payoff and then the list of advertisements may be segmented into ranked groups. An unsampled advertisement may then be choosen from each group, allocated a web page placement corresponding to the group's web page placement, and sampled in an online advertising auction.

At the end of each round, the click-through rate for each of the sampled advertisements may be updated using a normalized number of clicks in order to compare click-through rates across web page placement locations of different quality, and sampled advertisements with an updated click-through rate lower than a threshold may be removed from the set of advertisements. When the remaining number of advertisements may no longer exceed the number of web page placements, the advertisements may be allocated to web page placements in order to maximize the revenue to the auctioneer. A charge may be calculated for each advertisement allocated to web page placements and sampled in the online advertising auction.

An online auction application may deploy the present invention to learn the valuation of new advertisements using sampling in an online auction. Through a process of valuation discovery, the click-through rate for advertisements may be learned and as the process of valuation discovery progresses, the present invention may more closely approximate the click-through rates for advertisements in order to allocate web page placements of different quality to advertisements that may maximize the welfare of the advertisers. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for using sampling for scheduling advertisements in an online auction, in accordance with an aspect of the present invention;

FIG. 3 is a flowchart generally representing the steps undertaken in one embodiment for scheduling advertisements in an online auction using sampling, in accordance with an aspect of the present invention;

FIG. 4 is a flowchart generally representing the steps undertaken in one embodiment for generating an initial list of advertisements ordered by expected payoff, in accordance with an aspect of the present invention;

FIG. 5 is a flowchart generally representing the steps undertaken in one embodiment for updating the click-through rate for each sampled advertisement using a normalized number of clicks, in accordance with an aspect of the present invention;

FIG. 6 is a flowchart generally representing the steps undertaken in one embodiment for determining an optimal subset of advertisements for web page placements, in accordance with an aspect of the present invention; and

FIG. 7 is a flowchart generally representing the steps undertaken in one embodiment for sampling advertisements, in accordance with an aspect of the present invention.

### DETAILED DESCRIPTION

### Exemplary Operating Environment

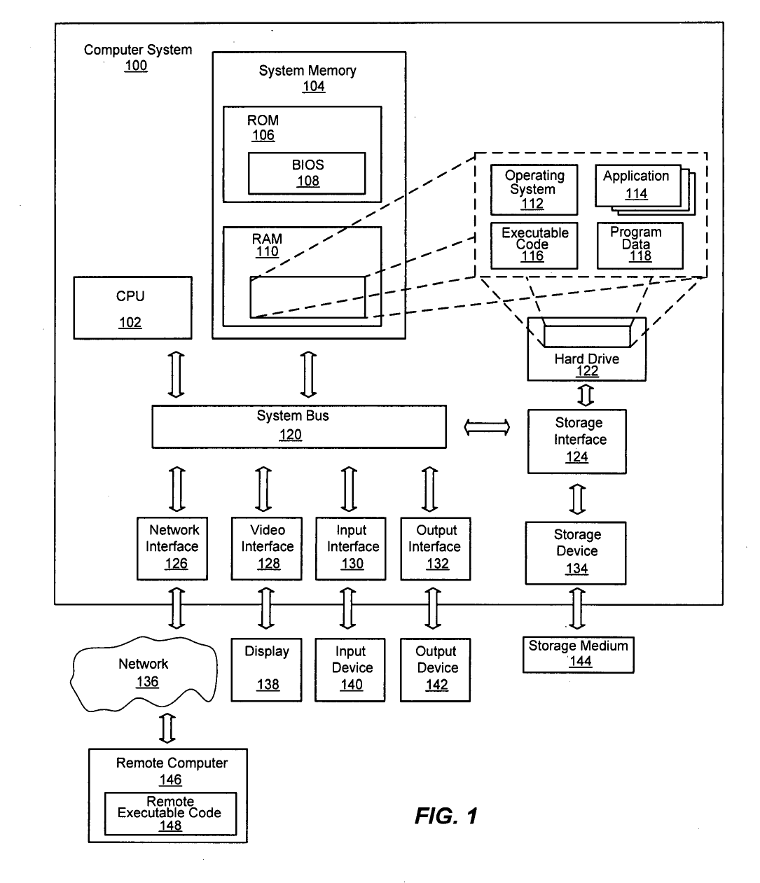

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Scheduling Advertisements in an Online Auction Using Sampling

The present invention is generally directed towards a system and method using sampling for scheduling advertisements in an online auction. A multi-armed bandit model may be created for sampling new advertisements by allocating advertisements for web page placements of different quality and optimizing payments to maximize the welfare of the advertisers. As used herein, a web page placement may mean a location on a web page designated for placing an advertisement for display. A web page placement may also include additional information such as a target group of visitors to be shown the advertisement. An online auction application may deploy a multi-armed bandit engine to learn the valuation of new advertisements using sampling in an online auction. Through a process of valuation discovery, the click-through rate for advertisements may be learned and the value of advertisements to advertisers may be learned. As the process of valuation discovery progresses, the algorithm more closely approximates the click-through rates for advertisements in order to allocate web page placements to advertisements that may maximize the welfare of the advertisers.

As will be seen, the framework described may support many online auction applications for learning the valuation of new advertisements. For example, online advertising applications may use the present invention to optimize bids for auctioning advertisement placement for keywords of search queries. As will be understood, the various block diagrams, flow charts and scenarios described herein are only examples, and there are many other scenarios to which the present invention will apply.

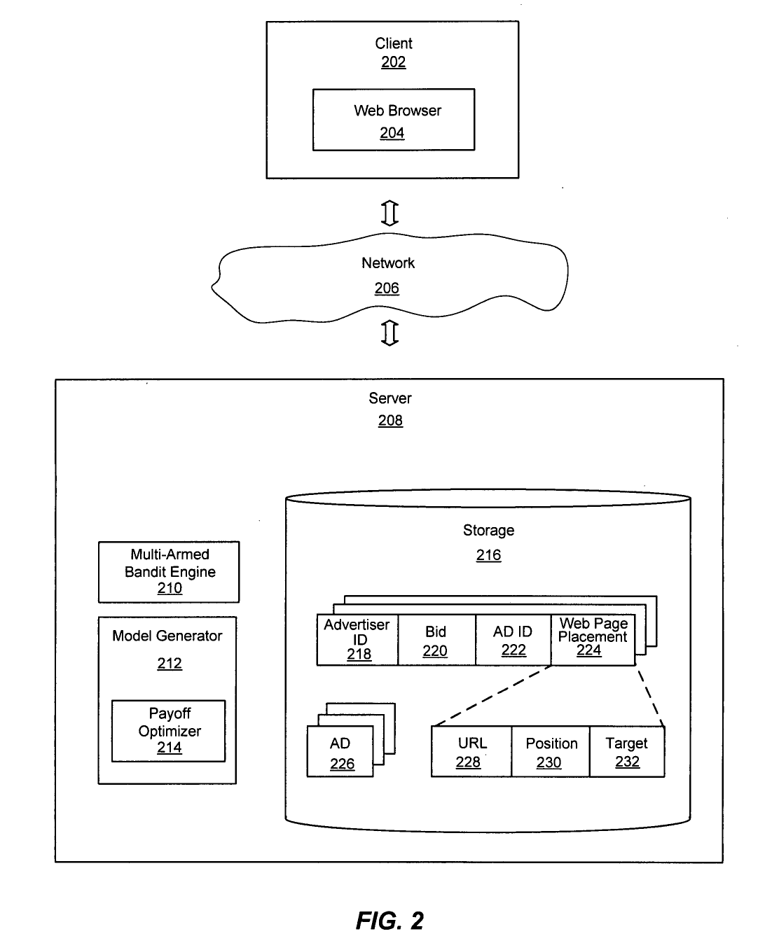

Turning to FIG. 2 of the drawings, there is shown a block diagram generally representing an exemplary architecture of system components for using sampling for scheduling advertisements in an online auction. Those skilled in the art will appreciate that the functionality implemented within the blocks illustrated in the diagram may be implemented as separate components or the functionality of several or all of the blocks may be implemented within a single component. For example, the functionality for the model generator 212 may be included in the same component as the multi-armed bandit engine 210. Or the functionality of the payoff optimizer 214 may be implemented as a separate component from the model generator 212. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a search request which may be input by a user entering a query. The web browser 204 may include functionality for receiving a query entered by a user and for sending a query request to a server to obtain a list of search results. In general, the web browser 204 may be any type of interpreted or executable software code such as a kernel component, an application program, a script, a linked library, an object with methods, and so forth.

The server 208 may be any type of computer system or computing device such as computer system 100 of FIG. 1. In general, the server 208 may provide services for query processing and may include services for providing a list of auctioned advertisements to accompany the search results of query processing. In particular, the server 208 may include a multi-armed bandit engine 210 for choosing advertisements for web page placement locations, a model generator 212 for creating a multi-armed bandit model used by the multi-armed bandit engine 210, and a payoff optimizer 214 for optimizing payments to maximize the welfare of the advertisers. Each of these modules may also be any type of executable software code such as a kernel component, an application program, a linked library, an object with methods, or other type of executable software code.

The server 208 may be operably coupled to a database of information such as storage 216 that may include an advertiser ID 218 that may be associated with a bid amount 220 for an advertisement referenced by advertisement ID 222 to be displayed according to the web page placement 224. The web page placement 224 may include a Uniform Resource Locator (URL) 228 for a web page, a position 230 for displaying an advertisement on the web page, and a target ID 232 for referencing a target or group of visitors that may be defined by a profile of characteristics that may match a visitor of the web page. In various embodiments, a target may be defined by demographic information including gender, age, or surfing behavior. Any type of advertisements 226 may be associated with an advertisement ID 218. Advertisers may have multiple advertiser IDs 218 representing several bid amounts for various web page placements and the payments for allocating web page placements for bids may be optimized using the multi-armed bandit engine to maximize the welfare of the advertisers.

There may be many applications which may use the present invention for scheduling advertisements in an online auction. For example, online advertising applications may use the present invention to optimize payment for auctioning advertisement placement for keywords of search queries. Or online advertising applications may use the present invention to optimize payments for classes of advertisements to be shown to classes of users. For any of these applications, advertisement auctions may optimize payments to maximize the welfare of the advertisers.

A classic multi-armed bandit (MAB) that may allow the allocation of different web page placements may be used to learn advertisers' valuations. In general, the multi-armed bandit is a well studied problem (see, for example, D. A. Berry and B. Fristedt, Bandit Problems, Sequential Allocation of Experiments, Chapman and Hall, 1985; H. Robbins, Some Aspects of the Sequential Design of Experiments, In Bulletin of the American Mathematical Society, volume 55, pages 527-535, 1952) which deals with the balancing of exploration and exploitation in online problems with multiple possible solutions. In the simplest version of the MAB problem, a user must choose at each stage (the number of stages is known in advance) a single bandit/arm. This bandit will yield a reward which depends on some hidden distribution. The user must then choose whether to exploit the currently best known distribution or to attempt to gather more information on a distribution that currently appears suboptimal. The MAB is known to be solvable via the Gittins index (see, for example, J. C. Gittins, Multi-armed Bandit Allocation Indices, Wiley, New York, Mathematical Reviews: MR90e:62113, 1989) and there are solutions which approximate the optimal expected payoff. Due to its simplicity and optimal sampling complexity, the MAB solution in E. Even-Dar, S. Manor, and Y. Mansour, PAC Bounds for Multi-Armed Bandit and Markov Decision Processes, The Fifteenth Annual Conference on Computational Learning Theory 2002, may be generalized for use in allowing the allocation of different web page placements may be used to learn advertisers' valuations.

Although the MAB has been extensively studied, it has generally been studied in the context of a single user choosing from non-strategic arms (see R. Kleinberg, Anytime Algorithms for Multi-Armed Bandit Problems, Proceedings of the 17^{th} ACM-SIAM Symposium on Discrete Algorithms (SODA 2006)), even when studied in the context of slot auctions (see S. Pandey and C. Oston, Handling Advertising of Unknown Quality in Search Advertising, NIPS 2006). However, the MAB has not been previously implemented in previous work as a truthful mechanism for strategic arms, allowing different slots with varying quality. In the context of an online auction for keywords, the arms/advertisers will act as strategic utility-maximizing agents. By defining the keyword problem as an instance of a truthful mechanism for MAB, the optimal payoff for the MAB may be approximated, and hence the optimal welfare for the auction may be approximated. As the algorithm achieves optimal sampling complexity, the welfare loss may be bounded from the sampling process.

When looking at randomized algorithms for mechanism design, the notion of truthfulness that may be used should be carefully selected. Since click through rates by users are being sampled, for any finite time horizon T, there is a finite probability that the sampling is done incorrectly and hence will influence the truthfulness. In this case, the notion of truthfulness with high probability due to A. Archer, C. Papadimitriou, K. Talwar, and E. Tardos, An Approximate Truthful Mechanism for Combinatorial Auctions with Single Parameter Agents, In Proc. of the 14th SODA, 2003, may be used for finite time horizons. Furthermore, the algorithm should also be truthful in expectation.

In the model of the present invention, N risk neutral, utility maximizing advertisers may bid for advertising slots based on a keyword. The present invention may also apply for a bidding process for multiple keywords since it may be analogous to bidding for a single keyword. Suppose without loss of generality that the keywords appear at every time t. Whenever that keyword appears in the search, Kₜ slots of advertisements appear in the results. Assume for the ease of exposition that Kₜ=Kₜ₊₁=K for all time period t. Also assume without the loss of generality that K=N, since superfluous slots can remain blank. Each advertiser i may have a private value for each click through which may be denoted by vᵢ. This value may be independent of the slot the ad originally appeared in.

Also assume that all of the advertisers may be present in the system throughout the entire running of the algorithm and that there may not be any budget constraints. The algorithm may run in time rounds starting at t=1 and ending at t=T. This model may study a one-shot incomplete information game, meaning that advertisers do not change their valuations in the different time periods of the algorithm and can not learn about each other's valuations.

Furthermore, assume that the “quality” of each slot j (which is essentially the probability of a click though if an advertisement appears in slot j) may be monotonically decreasing and may be independent of the advertisers. Thus, the first slot may have the highest probability to be clicked on regardless of the ad presented in it. The second slot may have the second highest probability to be clicked on, and so forth.

Since different slots may be of different quality, if advertiser a is presented in the first slot and gets a click and advertiser b is presented in the second slot and does not gets a click, advertiser a's click through rate may not be simply updated with an extra click and advertiser b's click through rate may not be simply reduced since as it may not be known what clicks may have happened if advertiser b was presented in the first slot. In order to be able to compare click through rates across slots, normalization constants may be defined between slots j−1 and j for all K≧j>1. A click in slot j may be denoted by rⱼ and an absence of a click in slot j may be denoted by [symbol] rⱼ. There may be four cases:
βⱼ¹—the probability that an advertisement would have been clicked in slot j (if it had been shown in slot j) given that it was clicked in slot j−1, i.e., βⱼ¹=Pr[rⱼ|rⱼ₋₁].
βⱼ²—the probability that an advertisement would have been clicked in slot j given that it was not clicked in slot j−1, i.e., βⱼ²=Pr[rⱼ| [symbol] rⱼ₋₁].
\tilde{β}ⱼ¹—the probability that an advertisement would have been clicked in slot j−1 given that it was clicked in slot j, i.e., \tilde{β}ⱼ¹=Pr[rⱼ₋₁|rⱼ].
\tilde{β}ⱼ²—the probability that an advertisement would have been clicked in slot j−1 given that it was not clicked in slot j, i.e., \tilde{β}ⱼ²=Pr[rⱼ₋₁| [symbol] rⱼ].

In general, the assumption that a click through rate decays monotonically with lower slots by the same factors for each advertiser has been widely assumed in practice and in theory. The common assumption of monotonicity may be generalized to assume that there may exist constants that allow the calculation of all of the conditional probabilities both when there may be a click through and when there is may not. Given the large data sets that search engines have, this assumption is well justified in practice.

Each advertiser i may have a click through rate αᵢ which may represent the probability of a click on the advertisement given that it appeared in the first slot. (The normalization constants enable the use of the first slot as a baseline.) This value may be unknown to i as well as to the mechanism. Since αᵢ may be unknown to i and the mechanism, it may be estimated at each time t and the observed probability may be denoted by αᵢ^{t}.

Finally, consider the bid for each click-through stated by advertiser i to the mechanism to be denoted by ν̅ᵢ (which might not be the true value). Also consider the price which advertiser i is charged at time t by the mechanism to be denoted by pᵢ^{t}≦ ν̅ᵢ. Assuming that advertisers may have a quasi-linear utility function, placing advertiser i at slot j at time t obtains an expected utility β₂¹ . . . βⱼ¹ αᵢ^{t}(vᵢ−pᵢ^{t}) per impression at time t.

A multi-armed bandit mechanism may be applied to this model of advertisers bidding for advertising slots based on a keyword. In general, the multi-armed bandit problem is a statistical decision model of an agent trying to optimize his decisions while improving his information at the same time. More particularly, in the multi-arm bandit problem, the gambler has to decide which arm of K different slot machines to play in a sequence of trials so as to maximize his reward.

In practice, the bandit problem may be formulated as an infinite horizon Markov decision problem in discrete time with time index t=0, 1, . . . T. At each time t the decision maker chooses amongst N arms and this choice may be denoted by aₜε{1, . . . , N}. If aₜ=i, a random payoff xₜⁱ is realized and the associated random variable may be denoted by Xₜⁱ. Applied to the model of the slot auction, xₜⁱ=αᵢ^{t}·νᵢ where the click through rate αᵢ^{t} may be the random payoff element of the problem while the value vᵢ may be a constant, hence the total payoff for arm i may be νᵢ×αᵢ^{t}. The state variable of the Markovian decision problem is given by sₜ, where in the model of the slot auction, a vector of all allocated advertisers click-through-rates at time t, αᵢ^{t} and 0 if i is not allocated a slot in time t. The distribution of xₜⁱ may be Fⁱ(•;sₜ).

The state transition function φ depends on the choice of the arm and the realized payoff: sₜ₊₁=φ(xₜⁱ;sₜ). Consider Sₜ to denote the set of possible states in period t. A feasible Markov policy

$$a = {\{ {a}_{t} \}}_{t = 0}^{∞}$$

may select an available alternative for each conceivable state sₜ, i.e., aₜ:Sₜ→{1, . . . , N}. Payoffs may be evaluated according to the discounted expected payoff criterion where the discount factor δ satisfies 0≦δ<1. The motivation for assuming a discount factor is that the seller of the slot auction prefers payment sooner rather than later. The payoff from each i depends only on outcomes of periods with aₜ=i. In other words, the state variable sₜ may be decomposed into N components (sₜ¹, . . . , sₜ^{N}) such that for all i:sₜ₊₁ⁱ=sₜⁱ if aₜ≠i, sₜ₊₁ⁱ=φ(sₜⁱ;xₜ) if aₜ=i, and Fⁱ(•;sₜ)=Fⁱ(•;sₜⁱ).

The algorithm for a multi-armed bandit mechanism applied to the model of advertisers bidding for advertising slots based on a keyword may be illustrated in an embodiment for the simple case when there may be a single slot available at any given time. The algorithm may start with a set S=N of all advertisers and without any knowledge of their click through rate. At each time period t and for each advertiser iεS, there may be an estimate of i's click through rate αₜⁱ as well as an estimate of how accurate the estimation is, i.e., a (probabilistic) bound on |αₜⁱ−αᵢ| which depends on the time period t that the algorithm sampled. This bound may be denoted by γ^{l}, where l may be the stage number as described below. Advertisers may be removed from the set S and may not be considered for sampling once the algorithm learns that their estimated click through rate is less than the maximum click through rate (even when adjusting for sampling errors).

The algorithm may execute in multiple stages. Each stage may consist of a variable number of rounds. When a stage starts, all advertisers in the set S may be considered. This set has an i such that νᵢ·αₜⁱ is maximal. Suppose without loss of generality that the maximal element is the first element considered in S. The algorithm could merely choose to do an exploitation, that is just allocate the slot to the first advertiser. However, there may be other possible advertisers that are worthy of consideration. These may be the advertisers j such that xᵢ^{t}−γ^{l}<xⱼ^{t}+γ^{l}. In this case, the inaccuracy of i, j overlap. Therefore the algorithm may allocate to this stage a sufficient number of rounds to sample all of these possible advertisers (for simplicity, assume without loss of generality that the time finishes, i.e., t=T, only when starting a new stage. If there is insufficient time to finish a stage, the algorithm simply does not sample in that stage.).

This algorithm may work if the players are non-strategic. Of course, if the players are strategic, then the players may need to be motivated to give the correct values vᵢ. Since all of the advertisers arrive and depart at the same time and only a single slot may be allocated at any given time, the price for any stage to be defined may be set as the critical value at that stage to be sampled (i.e. given sampled j such that νⱼ·αⱼ^{t} is maximal from among the advertisers not sampled, the price for player i may be

$$\frac{{v}_{j} \cdot {α}_{j}^{t}}{{α}_{t}^{i}} . )$$

In general, a multi-armed bandit auction algorithm may be applied for the general case when there may be multiple slots available at any given time. Moreover, the slots may be of different quality and care should be taken during the sampling procedure to allocate “better” slots to “better” advertisers which may optimize payment to maximize the welfare of the advertisers. The following pseudocode may represent the main algorithm for a multi-armed bandit auction when there may be multiple slots available at any given time:
MAB Auction Algorithm
1. All advertisers i report their value ν̅ᵢ
2. Set time t=1, l=1 and the set of advertisers S=N
3. Set initial click through rates for each i, x₁ⁱ=0
4. Randomly sample every advertiser iεS once.
   a. For every time t in stage l
   b. Normalize click-through rate(input:S, output: αᵢ^{t})
   c. t=t+1
5. l=l+1
6. define confidence parameter

$${γ}^{l} = \sqrt{\frac{log ( {cnl}^{2} / δ )}{l} \cdot \frac{1}{max \{ {β}_{2}^{1} \cdot … \cdot {β}_{K}^{1} , {\tilde{β}}_{K}^{2} \cdot {\tilde{β}}_{K - 1}^{1} \cdot … \cdot {\tilde{β}}_{2}^{1} \}} \cdot \frac{1}{K}} and {x}_{t}^{max K}$$

to be the Kth highest payoff x₁ⁱ of iεS
7. discard suboptimal advertisers: for each iεS such that

$${x}_{t}^{max K} - {x}_{t}^{i} \geq 2 {γ}^{l} set S = S \backslash i$$

8. If |S|>K (there are still too many possibilities) then allocate-slots-for-sampling (input:S, for all iεS xᵢ^{t}) Go to 5
9. decide which slots are allocated to which advertisers: match-K-slots (input:t,S output:for all iεS slot jεK)
10. from τ=t to T and for all iεS allocate advertiser i to slot j
11. if i got a click charge price of pᵢ^{t}: compute-ladder-price(input:i, jxₜ^{z}^{ⱼ₊₁}, . . . xₜ^{z}^{_{K}}, output: pᵢ^{t}), where zⱼ is the advertiser that was allocated slot j

In general, the algorithm samples each advertiser i in turn until there is a sufficient gap between the observed payoffs of the K highest advertisers and advertiser i such that with sufficient probability the i′^{th} advertiser is not one of the advertisers desirable to retain. The algorithm removes all of the advertisers with a sufficiently large gap and continues to sample the remaining advertisers as long as there is not a large enough gap between the best advertisers and the rest of the advertisers to remove them.

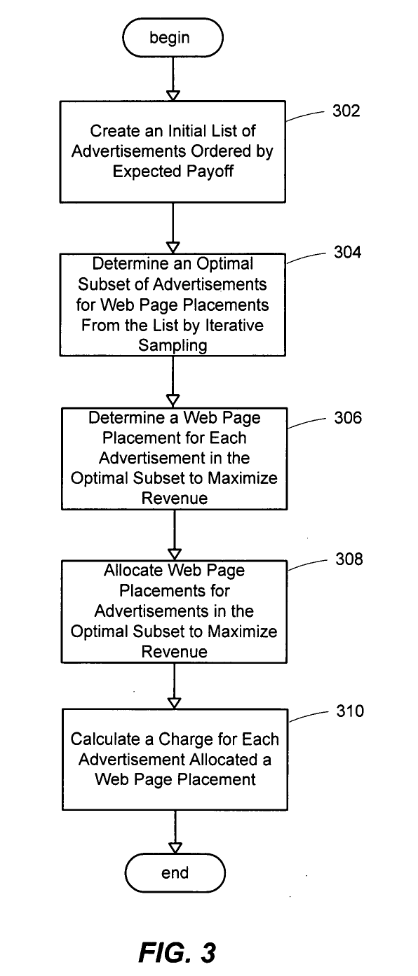

FIG. 3 presents a flowchart generally representing the steps undertaken in one embodiment for scheduling advertisements in an online auction using sampling. The steps of FIG. 3 represent the general steps of the pseudocode of the MAB Auction Algorithm presented above. At step 302, an initial list of advertisements ordered by expected payoff may be generated. An optimal subset of advertisements may be determined at step 304 for web page placements from the list by iterative sampling. Web page placements may be determined at step 306 for each advertisement in the optimal subset of advertisements to maximize the welfare of the advertisers. At step 308, web page placements may be allocated for advertisements in the optimal subset of advertisements to maximize the welfare of the advertisers. Finally, a charge may be calculated at step 310 for each advertisement allocated a web page placement.

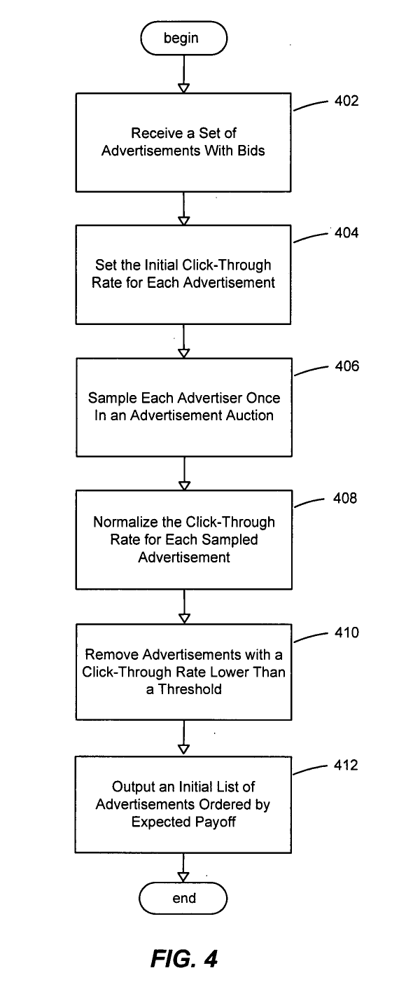

FIG. 4 presents a flowchart generally representing the steps undertaken in one embodiment for generating an initial list of advertisements ordered by expected payoff. At step 402, a set of advertisements may be received with bids. The initial click-through rate may be set at step 404 for each advertisement in the set of advertisements. Each advertisement may then be sampled at step 406 in an advertisement auction. In an embodiment, each advertisement may be sampled once. At step 408, the click-through rate for each sampled advertisement may be normalized. Advertisements may be removed at step 410 that may have a click-through rate lower than a threshold. At step 412, an initial list of advertisements ordered by expected payoff may be output.

The following pseudocode may represent the normalize-click-through-rate algorithm used by the MAB Auction Algorithm to normalize the click-through probabilities of different slots so that they can be compared to the same baseline slot:
Normalize-Click-Through-Rate (Input: S, Output: αᵢ^{t})
1. for every iεS that was given slot j:
   if i got a click, normalize the click by \tilde{β}ⱼ¹· . . . ·\tilde{β}₂¹ else normalize the click by \tilde{β}ⱼ²·\tilde{β}ⱼ₋₁¹· . . . ·\tilde{β}₂¹
   Update αᵢ^{t} (and xₜⁱ) accordingly
2. if i got a click charge price of pᵢ^{t}:
   compute-ladder-price(input:i, jxₜ^{z}^{ⱼ₊₁}, . . . , xₜ^{z}^{_{K}}, output: pᵢ^{t}), where zⱼ is the advertiser that was allocated slot j.

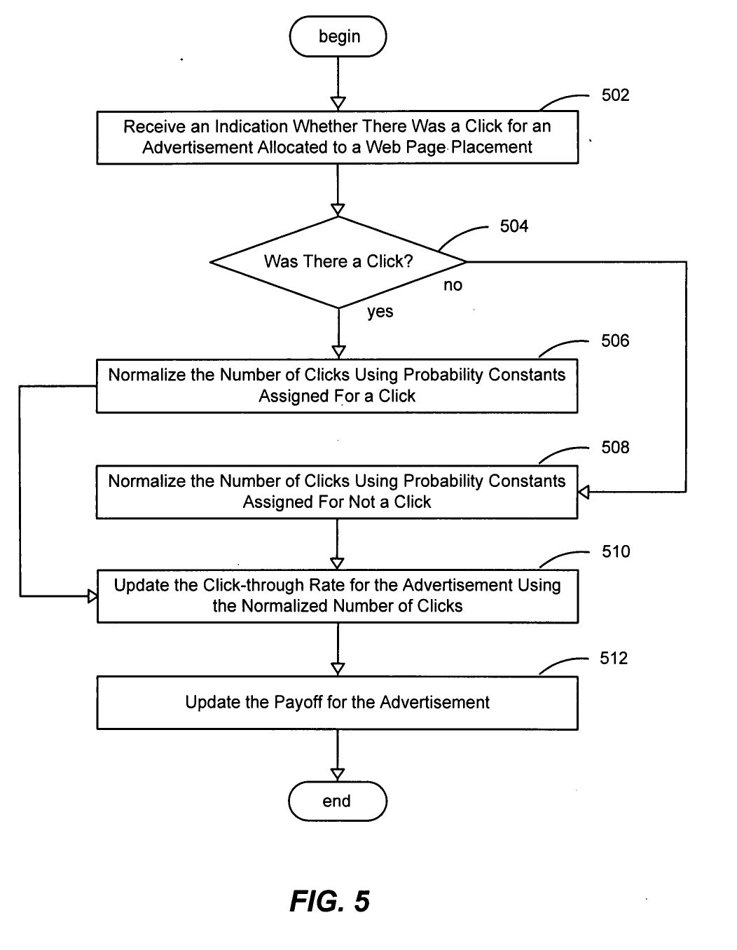

FIG. 5 presents a flowchart generally representing the steps undertaken in one embodiment for updating the click-through rate for each sampled advertisement using a normalized number of clicks. For example, step 408 of FIG. 4 above may use the steps of FIG. 5 to updating the click-through rate using a normalized number of clicks. At step 502, an indication may be received whether there was a click for an advertisement allocated to a web page placement. It may be determined at step 504 whether there was a click received for an advertisement allocated to a web page placement. If so, then the number of clicks may be normalized at step 506 using probability constants assigned for an advertisement that received a click. If not, then the number of clicks may be normalized at step 508 using probability constants assigned for an advertisement that did not receive a click. At step 510, the click-through rate for the advertisement may be updated using the normalized number of clicks. At step 512, the payoff for the advertisement may be calculated.

The following pseudocode may represent the allocate-slots-for-sampling algorithm used by the MAB Auction Algorithm to continue sampling the remaining advertisers as long as there is not a large enough gap between the best advertisers and the rest of the advertisers to remove them:
Allocate-Slots-For-Sampling (Input: S, ∀ iεS xᵢ^{t})
1. Order the payoffs xᵢ^{t} of iεS and denote the d′th high payoff by xᵢ_{_{d}}^{t}
2. Sample every advertiser iεS for every time t in stage l in the following order:
   For every slot jεK, chose an advertiser at random without repetition of i_{(j-1)(|S|/K)+1} to i_{j|S|\K}
      i. normalize-click-through-rate (input:S, output: αᵢ^{t})
      ii. t=t+1.

Once all advertisers are removed other than the most desired K, each advertiser needs to be allocated the proper slot, meaning the most desired advertiser in first slot, the second most desired in second slot, and so forth. This may be done by the Match-K-Slots Algorithm simply by ensuring that there is a sufficient gap between two consecutive advertisers observed probabilities.

The following pseudocode may represent the match-K-slots algorithm used by the MAB Auction Algorithm to allocated the proper slot to each advertiser:
Match-K-Slots (Input:t,S Output:for all iεS slot jεK) For z=1 to K−1:
1. sample all advertisements iεS
   a. for every time t in stage l:
      i. normalize-click-through-rate(input:S, output: αᵢ^{t})
      ii. if advertiser i′ that is allocated slot K−z+2 got a click charge p_{i′}^{t}, compute-ladder-price(input:i′,K−z+1, xₜ^{z}^{_{K−z+2}}, . . . , xₜ^{z}^{_{K}}, output: pᵢ^{t})
      iii. t=t+1
2. Use confidence parameter

$${γ}^{l} = \sqrt{\frac{log ( {cnl}^{2} / δ )}{l} \cdot \frac{1}{max \{ {β}_{2}^{1} \cdot … \cdot {β}_{K}^{1} , {\tilde{β}}_{K}^{2} \cdot {\tilde{β}}_{K - 1}^{1} \cdot … \cdot {\tilde{β}}_{2}^{1} \}} \cdot \frac{1}{K - z}}$$

3. for every advertiser iεS such that

$${x}_{t}^{max K - z} - {x}_{t}^{i} \geq 2 {γ}^{l}$$

set S=S\i
4. allocate the removed i in slot K−z+1.

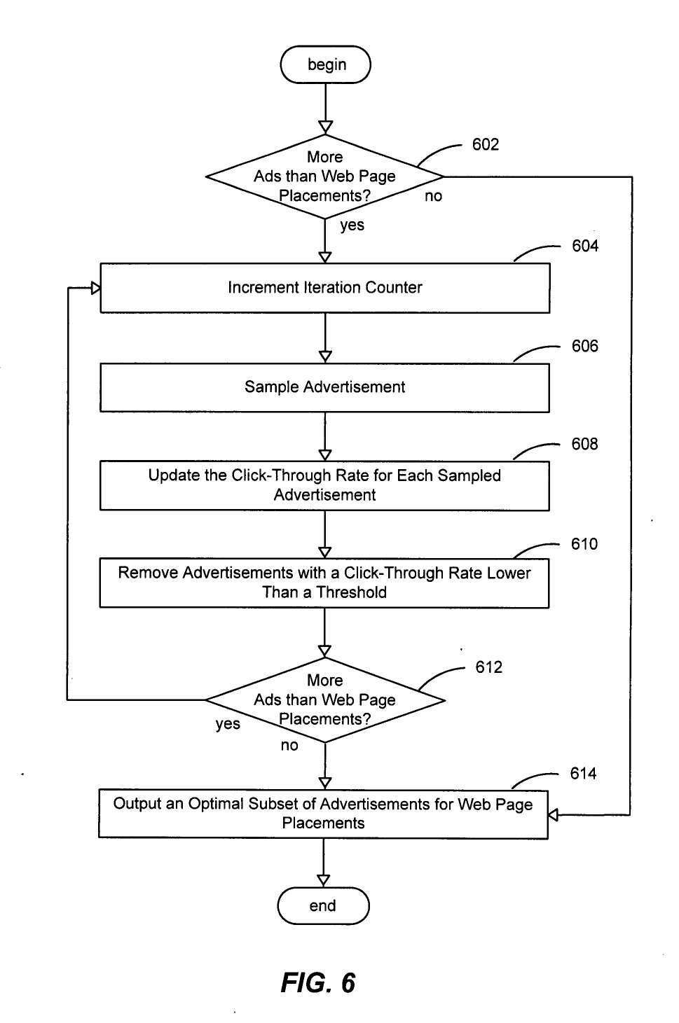

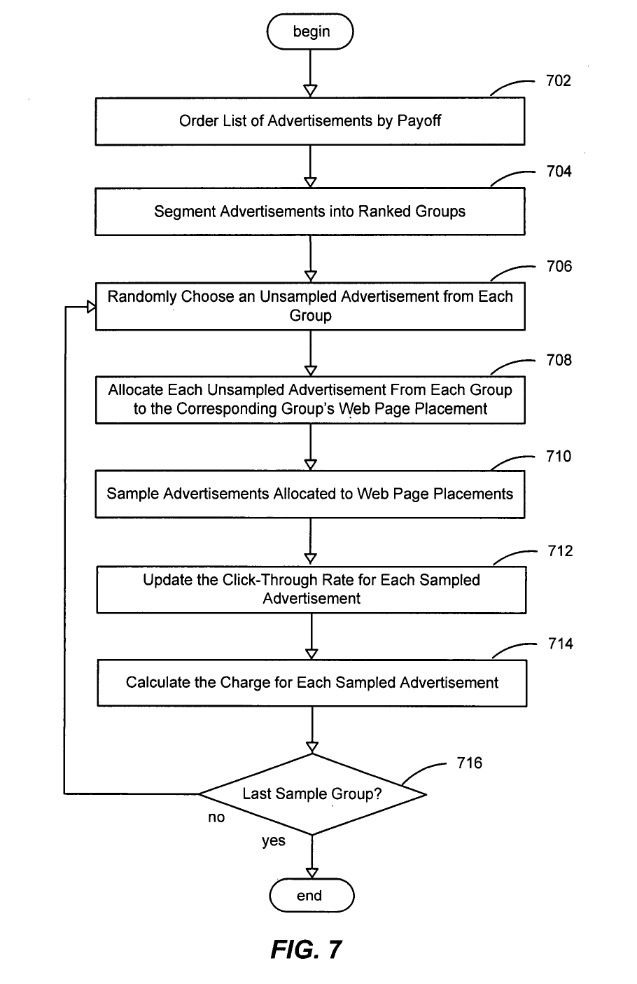

In general, FIG. 6 and FIG. 7 represent the steps in an embodiment to continue sampling remaining advertisers as long as there is not a large enough gap between the best advertisers and the rest of the advertisers, or otherwise remove them and then allocate the proper slots to the most desired K advertisers. FIG. 6 presents a flowchart generally representing the steps undertaken in one embodiment for determining an optimal subset of advertisements for web page placements. For instance, step 304 of FIG. 3 above may use the steps of FIG. 6 to determine an optimal subset of advertisements from the list of advertisements for web page placements by iterative sampling. At step 602, it may be determined whether there may be more advertisements than locations for web page placements. If not, then an optimal subset of advertisements for web page placements may be output at step 614. For instance, the initial list of advertisements may be less than or equal to the number of web page placements. Otherwise, an iteration counter may be incremented at step 604 and advertisements may be sampled at step 606. In general, the advertisements may be segmented into groups and iteratively sampled by randomly allocating a web page placement for an ad from each group as described below in more detail in conjunction with FIG. 7. At step 608, the click-through rates for each sampled advertisement may be updated using the normalized number of clicks. Sampled advertisements with a click-through rate lower than a threshold may be removed at step 610. It may then be determined whether there may be more advertisements than locations for web page placements at step 612. If so, then processing may continue at step 604. Otherwise, an optimal subset of advertisements for web page placements may be output at step 614.

FIG. 7 presents a flowchart generally representing the steps undertaken in one embodiment for sampling advertisements. At step 702, a list of advertisements may be ordered by payoff. At step 704, the list of advertisements ordered by payoff may be segmented into ranked groups. In an embodiment, the number of groups into which the list of advertisements may be segmented may be the same as the number of web page placements. At step 706, an advertisement that has not yet been sampled during the processing steps described in FIG. 7 may be randomly choosen from each group. At step 708, a web page placement corresponding to each group may be allocated for each unsampled advertisement choosen from each group. At step 710, the advertisements for which web page placements have been allocated may be sampled in an online auction. For instance, the advertisements may be displayed on a web page in the allocated location of the web page placement and a user may select the advertisement using an input device such as a mouse. The advertisements may be sampled in this fashion for a particular time period. At step 712, the click-through rate for each sampled advertisement may be updated using the normalized number of clicks. Then the charge per click for each sampled advertisement may be calculated at step 714. It may be determined whether the last group of advertisements have been sampled. If not, then processing may continue at step 706 and an unsampled advertisement may be randomly selected from each group to be sampled. Otherwise, processing may be finished for sampling advertisements.

In order to motivate the advertisers to honestly report their bids, prices may be set using the compute-ladder-price algorithm. The prices may be computed by the compute-ladder-price algorithm following the truthful ladder scheme of G. Aggarwal, A. Goel and R. Motwani, Truthful Auctions for Pricing Search Keywords, Proceeding of EC'06. The following pseudocode may represent the compute-ladder-price algorithm for setting prices:
Computer-Ladder-Price(Input: i, j, xₜ^{z}^{ⱼ₊₁}, . . . , xₜ^{z}^{_{K}}, Output: pᵢ^{t}) 1 for f=j+1 to Kα_{z}_{_{f}}^{t}=xₜ^{z}^{_{ff}}/ν_{z}_{_{f}}

$$2 {p}_{i}^{t} = {\sum }_{f = j}^{K} ( \frac{{α}_{i}^{t} \cdot {β}_{2}^{1} \cdot … \cdot {β}_{f}^{1} - {α}_{i}^{t} \cdot {β}_{2}^{1} \cdot … \cdot {β}_{f + 1}^{1}}{{α}_{i}^{t} \cdot {β}_{2}^{1} \cdot … \cdot {β}_{j}^{1}} ) \frac{{α}_{{z}_{f + 1}}^{t}}{{α}_{i}^{t}} {v}_{{z}_{f + 1}}$$

Thus the present invention may truthfully schedule advertisements in an online auction using sampling. The algorithm employed is truthful in high probability, the allocation of different advertisers to different web page placements during the execution of the algorithm is truthful, and the final matching between web page placement locations and the highest estimated advertisers is truthful. Moreover, the system and method may approximate the optimal welfare of the participants while bounding the loss of welfare on the bandit sampling process.

As can be seen from the foregoing detailed description, the present invention provides an improved system and method for using sampling for scheduling advertisements in an online auction. Through a process of valuation discovery, the click-through rate for advertisements may be learned and the value of advertisements to advertisers may be learned. As the process of valuation discovery progresses, the multi-armed bandit engine more closely approximates the click-through rates for advertisements in order to allocate web page placements to advertisements that may maximize the welfare of the advertisers. Such a system and method may provide advertisers an incentive to declare bids with true valuations, accurately learn the CTR for new advertisements, support multiple advertising slots of different quality, and minimize loss of welfare of the advertisers As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for learning the click-through rate in online advertising auctions, comprising:
a multi-armed bandit engine for learning the valuation of advertisements through sampling by scheduling the advertisements for web page placements in an online advertising auction to optimize payments for maximizing welfare of advertisers; and
a storage operably coupled to the multi-armed bandit engine for storing a plurality of bids each associated with an advertisement allocated to web page placements in the online advertising auction.

2. The system of claim 1 further comprising a model generator for creating a multi-armed bandit model used by the multi-armed bandit engine.

3. The system of claim 1 further comprising a payoff optimizer operably coupled to the multi-armed bandit engine for optimizing payments for the advertisements sampled in the online advertising auction to maximize the welfare of the advertisers.

4. A computer-readable medium having computer-executable components comprising the system of claim 1.

5. A computer-implemented method for learning the click-through rate in online advertising auctions, comprising:
creating an initial list of advertisements ordered by expected payoff;
determining an optimal subset of advertisements for web page placements from the initial list by iterative sampling;
determining a web page placement for each advertisement in the optimal subset to maximize revenue;
allocating web page placements for each advertisement in the optimal subset to maximize revenue; and
calculating a charge for each advertisement allocated the web page placement.

6. The method of claim 5 wherein creating an initial list of advertisements ordered by expected payoff comprises:
receiving a set of advertisements with bids;
setting the initial click-through rate for each advertisement in the set of advertisements; and
sampling each of the set of advertisements once in the online advertising auction.

7. The method of claim 6 further comprising:
updating the click-through rate for each sampled advertisement using a normalized number of clicks;
removing sampled advertisements with a click-through rate lower than a threshold; and
outputting the initial list of advertisements ordered by expected payoff.

8. The method of claim 6 further comprising:
removing sampled advertisements with a click-through rate lower than a threshold; and
outputting the initial list of advertisements ordered by expected payoff.

9. The method of claim 5 wherein determining an optimal subset of advertisements for web page placements from the initial list by iterative sampling comprises:
determining whether there may be more advertisements in the initial list than the number of web page placements available for allocating advertisements; and
if so, sampling advertisements from the initial list in an online auction.

10. The method of claim 9 further comprising:
updating the click-through rate for each sampled advertisement using a normalized number of clicks;
removing sampled advertisements with a click-through rate lower than a threshold; and
outputting an optimal subset of advertisements for web page placements.

11. The method of claim 9 further comprising:
updating the click-through rate for each sampled advertisement using a normalized number of clicks;
removing sampled advertisements with a click-through rate lower than a threshold;
determining whether there may be more advertisements remaining than the number of web page placements available for allocating advertisements; and
if so, continue sampling the advertisements remaining in an online auction.

12. The method of claim 9 wherein sampling advertisements from the initial list in an online auction comprises:
ordering the initial list of advertisements by payoff;
segmenting the initial list of advertisements into ranked groups;
randomly selecting an unsampled advertisement from each of the groups;
allocating each selected unsampled advertisement from each group to a web page placement corresponding to each group; and
sampling the advertisements allocated to the web page placements in the online auction.

13. The method of claim 12 further comprising:
updating the click-through rate for each advertisement sampled in the online auction using a normalized number of clicks; and
calculating a charge for each advertisement sampled in the online auction.

14. The method of claim 13 further comprising:
determining whether the last sample group of advertisements from the initial list ordered by payoff have been sampled;
if not, randomly selecting an unsampled advertisement from each of the groups;
allocating each selected unsampled advertisement from each group to a web page placement corresponding to each group; and
sampling the advertisements allocated to the web page placements in the online auction.

15. The method of claim 10 wherein updating the click-through rate for each sampled advertisement using a normalized number of clicks comprises:
updating the click-through rate for each sampled advertisement using probability constants; and
updating the payoff for each sampled advertisement.

16. A computer-readable medium having computer-executable instructions for performing the method of claim 5.

17. A computer system for learning the click-through rate in online advertising auctions, comprising:
means for determining an optimal subset of advertisements for web page placements from an initial list of advertisements by iterative sampling;
means for determining a web page placement for each advertisement in the optimal subset to maximize revenue;
means for allocating web page placements for each advertisement in the optimal subset to maximize revenue; and
means for calculating a charge for each advertisement allocated the web page placement.

18. The method of claim 17 further comprising means for creating the initial list of advertisements ordered by expected payoff.

19. The computer system of claim 17 wherein means for determining an optimal subset of advertisements for web page placements from the initial list by iterative sampling comprises:
means for determining whether there may be more advertisements in the initial list than the number of web page placements available for allocating advertisements; and
means for sampling advertisements from the initial list in an online auction.

20. The computer system of claim 19 further comprising:
means for updating the click-through rate for each sampled advertisement;
means for removing sampled advertisements with a click-through rate lower than a threshold; and
means for outputting an optimal subset of advertisements for web page placements.
